(19) United States
(12) Patent Application Publication
(10) Pub. No.: US 2019/0212307 A1
(43) Pub. Date: Jul. 11, 2019

(54) METHOD FOR DETECTING A MALFUNCTION OF A FLUID SENSING SYSTEM

(71) Applicant: PLASTIC OMNIUM ADVANCED INNOVATION AND RESEARCH, Bruxelles (BE)

(72) Inventors: Tae Kyung KIM, Troy, MI (US); Charbel NAHED, Rochester, MI (US)

(73) Assignee: PLASTIC OMNIUM ADVANCED INNOVATION AND RESEARCH, Bruxelles (BE)

(21) Appl. No.: 16/315,053

(22) PCT Filed: Jul. 3, 2017
(86) PCT No.: PCT/EP2017/066420

§ 371 Date: Jan. 3, 2019

Related U.S. Application Data
(60) Provisional application No. 62/358,455, filed on Jul. 5, 2016.

(30) Foreign Application Priority Data
Aug. 23, 2016 (EP) 16185336.1

(51) Int. Cl. G01N 29/44; G01N 29/30; G01N 29/024; G01H 5/00

(52) U.S. Cl. CPC G01N 29/4427; G01N 29/30; G01N 29/024; G01H 5/00; G01N 2291/101; G01N 2291/02809; G01N 2291/0228; G01N 2291/011; G01N 2291/02836

(57) ABSTRACT

It is proposed a method for detecting a malfunction of a dual-sensing system for sensing a fluid mixture stored in a tank of a vehicle, the dual-sensing system being able to provide values of two physical quantities, i.e. one quantity indicative of a concentration of a constituent of the fluid mixture within the tank and one quantity indicative of a level of the fluid mixture within the tank, the dual-sensing system comprising: a first ultrasound subsystem for determining the value of the physical quantity indicative of the concentration of the constituent of the fluid mixture; and a second ultrasound subsystem for determining, based on the value provided by the first ultrasound subsystem, the value of the physical quantity indicative of the level of the fluid mixture within the tank, the method comprises the steps of: when key is off: memorizing the last known value of a first physical quantity out of the two physical quantities and the last known value of a second physical quantity out of the two physical quantities; when key is on, sequentially: having new values of the two physical quantities provided by the dual-sensing system; if the last known value of the first physical quantity is not the same as the new value of the first physical quantity, stop the carrying out of the method; if the last known value of the second physical quantity is not the same as the new value of the second physical quantity, emitting a signal indicative of malfunctioning.

### FIELD OF THE INVENTION

The present invention relates to fluid sensing systems and, more particularly to systems for determining the quality/concentration and the level of a fluid mixture within a tank of a vehicle. For example, the fluid mixture may be an aqueous urea solution stored in a tank of an SCR system or a fuel mixture stored in a tank on board a vehicle. More precisely, the invention relates to a method for detecting a malfunction of such systems.

### BACKGROUND OF THE INVENTION

U.S. Pat. No. 8,733,153B2 discloses a dual-sensing system for determining both a quality and a level of a urea solution in a vehicle tank. The dual-sensing system includes two piezoelectric ultrasonic transducers. A quality transducer is positioned to reflect ultrasonic sound waves off a reflector and a level transducer is positioned to reflect ultrasonic sound waves off a surface of the urea solution. U.S. Pat. No. 8,733,153B2 further discloses on-board diagnostics configured to detect an error condition based on an incorrect calculated speed of sound through the fluid. This document does not, however, describe how a malfunction of the quality transducer can be detected in order to avoid relying on erroneous measurements in the event of a malfunction of the quality transducer.

### SUMMARY OF THE INVENTION

It is an object of the invention to provide a method for verifying the plausibility (i.e. detecting a malfunction) of a quality sensor of a dual-sensing system.

According to a first aspect of the invention, it is provided a method for detecting a malfunction of a dual-sensing system for sensing a fluid mixture stored in a tank of a vehicle, the dual-sensing system being able to provide values of two physical quantities, i.e. one quantity indicative of a concentration of a constituent of the fluid mixture within the tank and one quantity indicative of a level of the fluid mixture within the tank. The dual-sensing system comprises:
a first ultrasound subsystem for determining the value of the physical quantity indicative of the concentration of the constituent of the fluid mixture; and
a second ultrasound subsystem for determining, based on the value provided by the first ultrasound subsystem, the value of the physical quantity indicative of the level of the fluid mixture within the tank.

The first ultrasound subsystem is sometimes called «concentration sensor» or «quality sensor», although it does not necessarily provide a concentration measure, nor a quality measure. The second ultrasound subsystem is sometimes called «level sensor», although it does not necessarily provide a level measure.

The method of the invention comprises the steps of:
when key is off: memorizing the last known value of a first physical quantity out of the two physical quantities and the last known value of a second physical quantity out of the two physical quantities;
when key is on, sequentially:
   having new values of the two physical quantities provided by the dual-sensing system;
   if the last known value of the first physical quantity is not the same as the new value of the first physical quantity, stop the carrying out of the method;
   if the last known value of the first physical quantity is the same as the new value of the first physical quantity and if the last known value of the second physical quantity is not the same as the new value of the second physical quantity, emitting a signal indicative of malfunctioning;
   otherwise, optionally, emitting a signal indicative of plausible functioning.

In the instant invention, «when key is on» means the time following the start of the engine. «when key is off» means the time following the stop of the engine. «Key on» designates the operation of igniting the engine. «Key off» designates the operation of shutting off the engine.

According to a first embodiment of the invention, the physical quantity indicative of the concentration is the concentration itself and the physical quantity indicative of the level is the level itself.

In a first variant of this embodiment, the steps of the method are carried out in this manner:
when key is off: memorizing the last known concentration and last know level of the fluid mixture within the tank;
when key is on:
a) having a new level determined by the dual-sensing system;
b) if the new level and memorized last known level are not the same, stop the carrying out of the method;
c) having a new concentration value determined by the first ultrasound subsystem;
d) if the last known concentration value and new concentration value are not the same, emitting a malfunction signal indicative of a malfunction.

The signal emitted can be sent to a central ECU to inform the user of the car and to invite him to have it fixed shortly.

According to the invention, two values are not the same if they do not fall in a same range specified by a tolerance value. For instance, the new level and last know level not being the same means that they differ from at least 4% of the smallest value. As well, the new concentration value and last known concentration value are not the same if they differ from at least 4% of the smallest value.

The idea behind the present invention is to check the consistency of measures given at two different times (before and after an engine stop) without modification of the fluid mixture within the tank. If the data provided by the dual-sensing system is consistent from one measure to another measure, separated by a key off-key on sequence of operations, then the system (usually the concentration sensor, considered as more vulnerable) is considered as functioning plausibly. The plausibility principle is that if a first one of the two values occurs again, the likelihood that the second value has changed is low. However, it is to be noted that it is not impossible that a change in the second value only occurs in the fluid mixture. For instance, a change of concentration could theorically occur, for instance if the content of the tank is replaced, without any change of fluid level. This will result in constant level value after key on. This circumstance is deemed very unlikely according to the invention: if only one out of the two physical quantities changes, then something is wrong and the system is not working plausibly.

In a particular embodiment, each ultrasound subsystem comprises:
a piezoelectric ultrasonic transducer,
means to measure a duration of a predetermined number of reflections of ultrasonic waves on a distance within the fluid mixture.

In this embodiment, in the first subsystem, there is a reflector and the distance between the transducer and the reflector is a constant value. In the second subsystem, there is no physical element as a reflector but reflection of the ultrasonic waves takes place thanks to the interface of the fluid mixture with the vapor space in the tank. In the second subsystem, the distance between the transducer and the interface represents (i.e. is linked by a one-to-one relation) the level value of the fluid mixture in the tank.

It is proposed to launch the method according to the invention subsequent to the detection of an event indicating that the fluid mixture is in a stable position in the tank. More precisely, the execution of the method is conditioned to the detection that the interface of the fluid mixture with the vapor space in the tank is in a stable position, i.e. the variation of the position of the interface stays within a predetermined variation range.

In a particular embodiment, the distance is used to calculate a speed of sound value (SoS) based on the following relationship:

SoS=D×N×2/T; where
D is the distance;
T is the time measurement for the multiple echo reflection; and
N is the number of reflections.

Then the calculated speed of sound value (SoS) is applied to a look-up table for determining a concentration value.

It is an advantage of the present invention that it provides a robust method for assessing the malfunction of the dual-sensing system, by correlating the memorized and measured concentration and level values. For example, if a deviation is detected between the memorized concentration value and the measured concentration value, it may be concluded that an error of the first ultrasound subsystem is present.

In an alternative embodiment, the speed of sound value determined by the first ultrasound subsystem can be used as such to detect a malfunction of the first ultrasound subsystem. More precisely, in this case, the physical quantity indicative of the concentration is the speed of sound within the fluid mixture.

In another embodiment, which can be combined with the previous embodiment, the physical quantity indicative of the level of fluid mixture is the distance between the transducer and the interface fluid/vapor space in the second subsystem.

According to a combination of these two embodiments of the present invention, the steps of the method are carried out in the following manner:
on key off: memorizing the last known speed of sound value and distance value;
on key on:
   detecting an unchanged position of the interface of the fluid mixture with a vapor space within the tank between key off and key on, by comparing the memorized distance value with a new distance value provided by the dual-sensing system;
   operating the second ultrasound subsystem for determining a new speed of sound value;
   determining a malfunction of the first ultrasound subsystem using the first and second speed of sound values.

This alternative embodiment is simpler to implement since it does not make use of a specific look-up table for determining a concentration value.

According to another embodiment of the invention, the physical quantity indicative of the concentration is the duration of a predetermined number of reflections of ultrasonic waves within the fluid mixture on the known distance between the transducer and the reflector of the first subsystem. In other words, in this embodiment, the value of first physical quantity memorized when key off, it is a duration.

According the another embodiment, which can be combined with the previous embodiment, the physical quantity indicative of the level is the duration of a predetermined number of reflections of ultrasonic waves within the fluid mixture on the distance between the transducer and the interface liquid/space vapor in the second subsystem. In other words, in this embodiment, the duration of reflections is memorized as value of the second physical quantity when key off.

It is possible, through a combination of the two above embodiments, to memorize and compare durations only. This combined embodiment is simpler to implement since it does not make use of any specific look-up table nor calculation. The rough values of durations are immediately available for comparison.

In an embodiment, the step of determining whether the last known value of the first physical quantity is the same as the new value of the first physical quantity comprises:
operating the second ultrasound subsystem in the first sensing mode for determining a first level of fluid mixture at a first time, and a second level of fluid mixture at a second time;
calculating a deviation value upon the difference between the first and second levels of fluid mixture;
detecting an unchanged position of said interface when the deviation value does not exceed a predetermined threshold.

It is an advantage of the present invention that it provides a plausibility test of the first ultrasound subsystem, while monitoring the position of the interface.

In a particular embodiment, the fluid mixture is an aqueous urea solution. For example, the aqueous urea solution is stored in a urea tank and is used for SCR (Selective Catalytic Reduction) process.

In another particular embodiment, the fluid mixture is a liquid fuel (diesel, gasoline, etc.).

According to another aspect of the present invention, it is provided a computer program product comprising code means configured to cause a processor to carry out the steps of a method as described above.

### BRIEF DESCRIPTION OF THE DRAWINGS

The following drawings are illustrative of exemplary embodiments and therefore do not limit the scope of the invention. They are presented to assist in providing a proper understanding of the invention. The present invention will hereinafter be described in conjunction with the accompanying figures, in which:

FIG. 1 is a schematic view of an exemplary embodiment of a vehicle fluid storage system to which the present invention may be applied;

FIG. 2 illustrates a flowchart of operations depicting logical operational steps for detecting a malfunction of the system of FIG. 1, in accordance with a first particular embodiment of the invention; and

### DETAILED DESCRIPTION OF THE INVENTION

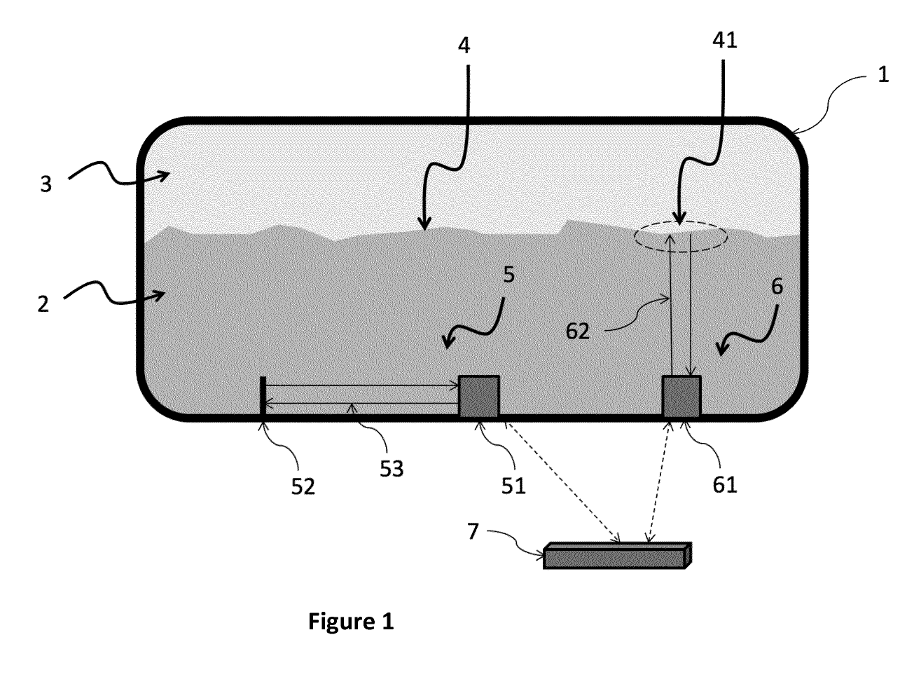

FIG. 1 illustrates an exemplary embodiment of a vehicle fluid storage system. As illustrated in the example of FIG. 1, the fluid storage system comprises:
a tank 1 for the storage of a fluid mixture 2, for example aqueous urea solution; and
a fluid dual-sensing system according to a particular embodiment of the present invention.

When fluid mixture 2 is present in the tank 1, the space not occupied by fluid mixture will be filled with a gas mixture. This space is referred to as the “vapor space” 3. The interface of the fluid mixture with the vapor space is referenced 4.

In the example of FIG. 1, the fluid dual-sensing system is designed to provide two physical quantities, one quantity indicative of a concentration of a constituent of the fluid mixture within the tank and one quantity indicative of a level of the fluid mixture within the tank. More specifically, the dual-sensing system comprises:
a first ultrasound subsystem 5 for determining a physical quantity which is characteristic of the concentration of a constituent of the fluid mixture,
a second ultrasound subsystem 6 for determining, based on the physical quantity provided by the first ultrasound subsystem, a physical quantity which is characteristic of the level of the fluid mixture within the tank, and
a controller 7 (also called electronic control unit or ECU).

The first ultrasound subsystem 5 comprises a piezoelectric ultrasonic transducer 51 and a reflector 52. The reflector 52 is located at a known distance from the transducer 51. Ultrasonic sound waves 53 generated by the transducer 51 propagate through the fluid mixture 2 and are reflected off the reflector 52 back towards the transducer 51. The reflected ultrasonic sound wave 53 is detected by transducer 51, and reflects off the transducer 51 back towards the reflector 52. The ultrasonic sound wave 53 can travel back and forth between the reflector 52 and the transducer 51 a predetermined number of times. The concentration results from a computation based on the speed of sound in the fluid mixture. The controller calculates a speed of sound value using the known distance value between transducer 51 and reflector 52 and the measured duration of ultrasonic reflections. The controller 7 applies the calculated speed of sound value to a look-up table for determining an estimated concentration value. The skilled person will be able to produce the required look-up table through routine experiments. The use of pulse-echo method (i.e. speed of sound technique) for determining the concentration/quality of a fluid mixture is well known and will not be described in any further detail.

The second ultrasound subsystem 6 comprises a piezoelectric ultrasonic transducer 61 positioned such that ultrasonic sound waves 62 produced by the transducer reflect off a zone 41 of the interface 4. The use of pulse-echo method (i.e. speed of sound technique) for determining the level of a fluid mixture in a tank is well known and will not be described in any further detail.

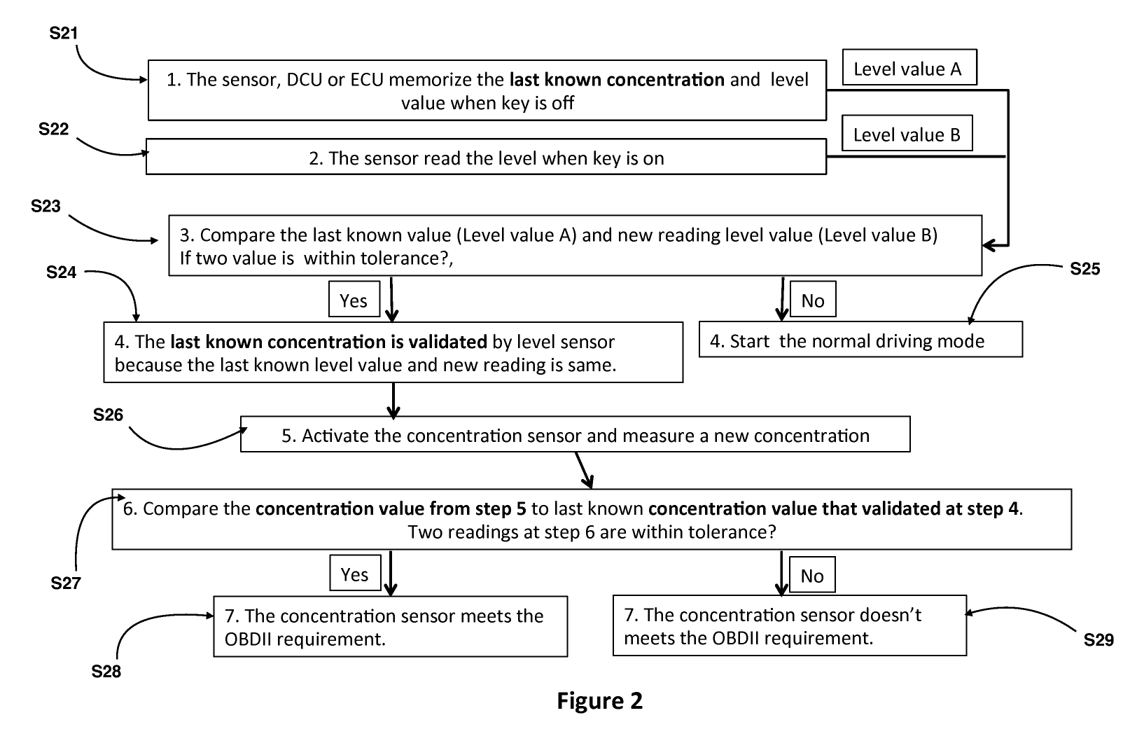

The controller 7 includes a series of computer-executable instructions, as described below in relation to FIG. 2, which allow the controller to determine a malfunction of the first ultrasound subsystem 5. These instructions may reside, for example, in a RAM of the controller. Alternatively, the instructions may be contained on a data storage device with a computer readable medium (for example, USB key or CD-ROM).

FIG. 2 illustrates a malfunction test according to a particular embodiment of the invention. More precisely, FIG. 2 illustrates a flowchart of instructions depicting logical operational steps for detecting a malfunction of the first ultrasound subsystem (i.e. quality sensor), in accordance with a particular embodiment of the invention.

Beginning at step S21, the sensor, DCU or ECU memorizes the last known concentration and level value when key off.

The controller 7 detects a vehicle key-off event. The controller 7 operates the dual-sensing system 6 for determining a first level of fluid mixture in the tank (Level value A). This first level value is obtained by measuring a reflection duration between transducer 51 and reflector 52 in the subsystem 5 and deducing from a look-up table the concentration of a constituent in the fluid mixture, then providing this concentration value to subsystem 6. Subsystem 6 measures a reflection duration between transducer 61 and interface 41 and deduces from this measure and from the concentration the distance between transducer 51 and interface 41. This distance allows to calculate the level of fluid mixture in the tank. This level is stored in a memory.

At step S22, the controller 7 detects a vehicle key-on event. The controller 7 operates again the dual-sensing system for determining a second level of fluid mixture in the tank (Level value B).

Then at step S23, the controller 7 determines whether the fluid mixture is in a stable position in the tank. To that purpose, the controller compares the first level (Level value A) and the second level (Level value B) and, for example, calculates a deviation value between the first level (Level value A) and the second level (Level value B). For example, the deviation value is compared to a predetermined threshold value. For example, the controller is configured to detect a stable position of the fluid mixture when the deviation value does not exceed the predetermined threshold value. If a stable position is detected, then the controller continues at step S24. If a stable position is not detected, then the malfunction test stops.

At step S24, the last known concentration is considered as validated by level sensor because the last known level value and new reading are the same. The consistency check (also called plausibility check) can take place.

At step S26, the subsystem 5 is activated by the controller and the subsystem 5 provides a new value of the concentration.

At step S27, the controller compares the new concentration value and the last known concentration value. For example, the controller calculates a deviation value between the effective concentration value and the last known concentration value. For example, the deviation value is compared to a predetermined threshold value. For example, the controller is configured to detect (step S27) a malfunction of the first ultrasound subsystem 5 when the deviation value exceeds the predetermined threshold value.

As a summary, out the two physical quantities:
the quantity indicative of a concentration of a constituent of the fluid mixture within the tank can be, not limitatively:
   the concentration value itself,
   the duration of ultrasonic wave reflections taking place in the fluid mixture on a known distance,
   the speed of the sound in the fluid mixture.
and the quantity indicative of a level of the fluid mixture within the tank can be, without being limited to:
   the level itself,
   the distance between a transducer and the interface between the fluid mixture and vapor space above the fluid mixture,
   the duration of ultrasonic wave reflections taking place in the fluid mixture between a transducer and the interface between the fluid mixture and vapor space above the fluid mixture.

Although the invention has been described hereinabove by reference to specific embodiments, this is done for illustrative and not for limiting purposes. Moreover, features disclosed in connection with one particular embodiment may be combined with features from other embodiments to obtain the same technical effects and advantages, without leaving the scope of the present invention.

1. A method for detecting a malfunction of a dual-sensing system for sensing a fluid mixture stored in a tank of a vehicle, the dual-sensing system being able to provide values of two physical quantities, one quantity indicative of a concentration of a constituent of the fluid mixture within the tank and one quantity indicative of a level of the fluid mixture within the tank, the dual-sensing system comprising:
a first ultrasound subsystem for determining the value of the physical quantity indicative of the concentration of the constituent of the fluid mixture; and
a second ultrasound subsystem for determining, based on the value provided by the first ultrasound subsystem, the value of the physical quantity indicative of the level of the fluid mixture within the tank,
the method comprising:
when key is off: memorizing the last known value of a first physical quantity out of the two physical quantities and the last known value of a second physical quantity out of the two physical quantities;
when key is on, sequentially:
having new values of the two physical quantities provided by the dual-sensing system;
if the last known value of the first physical quantity is not the same as the new value of the first physical quantity, stop the carrying out of the method; and
if the last known value of the first physical quantity is the same as the new value of the first physical quantity and if the last known value of the second physical quantity is not the same as the new value of the second physical quantity, emitting a signal indicative of malfunctioning.

2. The method according to claim 1, wherein each ultrasound subsystem comprises:
a piezoelectric ultrasonic transducer,
means to measure a duration of a predetermined number of reflections of ultrasonic waves on a distance within the fluid mixture.

3. The method according to claim 1, wherein, in the first subsystem, there is a reflector and the distance between the transducer and the reflector is a constant value, and, in the second subsystem, there is no physical element as a reflector but reflection of the ultrasonic waves takes place thanks to the interface of the fluid mixture with the vapor space in the tank.

4. The method according to claim 1, wherein the physical quantity indicative of the concentration is the concentration itself and the physical quantity indicative of the level is the level itself.

5. The method according to claim 1, wherein
when key is off: memorizing the last known concentration and last known level of the fluid mixture within the tank;
when key is on, sequentially:
a) having a new level determined by the dual-sensing system;
b) if the new level and memorized last known level are not the same, stopping the carrying out of the method;
c) having a new concentration value determined by the first ultrasound subsystem; and
d) if the last known concentration value and new concentration value are not the same, emitting a malfunction signal indicative of a malfunction.

6. The method according to claim 1, wherein the physical quantity indicative of the concentration is the speed of sound within the fluid mixture.

7. The method according to claim 1, wherein the physical quantity indicative of the level of fluid mixture is the distance between the transducer and the interface fluid/vapor space in the second subsystem.

8. The method according to claim 6, wherein
when key is off: memorizing the last known speed of sound value and distance value;
when key is on, sequentially:
detecting an unchanged position of the interface of the fluid mixture with a vapor space within the tank between key off and key on, by comparing the memorized distance value with a new distance value provided by the dual-sensing system;
operating the second ultrasound subsystem for determining a new speed of sound value; and
determining a malfunction of the first ultrasound subsystem using the first and second speed of sound values.

9. The method according to claim 1, wherein the physical quantity indicative of the concentration is the duration of a predetermined number of reflections of ultrasonic waves within the fluid mixture on the known distance between the transducer and the reflector of the first subsystem.

10. The method according to claim 1, wherein the physical quantity indicative of the level is the duration of a predetermined number of reflections of ultrasonic waves within the fluid mixture on the distance between the transducer and the interface liquid/space vapor in the second subsystem.

11. The method according to claim 1, wherein the fluid mixture is an aqueous urea solution.

12. A non-transitory computer readable medium storing computer readable instructions thereon that, when executed by a computer, causes the computer to perform the method according to claim 1.
